(19) United States
(12) Patent Application Publication
(10) Pub. No.: US 2026/0203551 A1
(43) Pub. Date: Jul. 16, 2026

(54) GRAPH INFORMATION PROCESSING APPARATUS, GRAPH INFORMATION PROCESSING METHOD AND NON-TRANSITORY COMPUTER READABLE STORAGE MEDIUM

(71) Applicant: KABUSHIKI KAISHA TOSHIBA, Kawasaki-shi Kanagawa (JP)

(72) Inventors: Kiichi GOTO, Kawasaki Kanagawa (JP); Yasutoyo TAKEYAMA, Kawasaki Kanagawa (JP); Ryusuke HIRAI, Tokyo (JP)

(73) Assignee: KABUSHIKI KAISHA TOSHIBA, Kawasaki-shi Kanagawa (JP)

(21) Appl. No.: 19/447,511

(22) Filed: Jan. 13, 2026

(30) Foreign Application Priority Data
Jan. 16, 2025 (JP) 2025-006234

(51) Int. Cl. G06N 3/042

(52) U.S. Cl. CPC G06N 3/042

(57) ABSTRACT

According to one embodiment, a graph information processing apparatus acquires graph data and processing mode information including one of a learning mode and an inference mode, calculates a local message based on a connection relation between a plurality of nodes of the graph data, the local message being obtained by aggregating information about multiple nodes, calculates a global message based on similarity between the nodes, the global message being obtained by adding the information about nodes, mixes the local message and the global message based on weighted average weight to updates the information about nodes, outputs no flag if the processing mode information is the learning mode and output a flag if the processing mode information is the inference mode, updates the weight according to whether the flag is input, and outputs the updated information about nodes.

### CROSS-REFERENCE TO RELATED APPLICATION

This application is based upon and claims the benefit of priority from prior Japanese Patent Application No. 2025-006234, filed Jan. 16, 2025, the entire contents of which are incorporated herein by reference.

### FIELD

Embodiments described herein relate generally to a graph information processing apparatus, a graph information processing method and a non-transitory computer readable storage medium

### BACKGROUND

Purchase data can be handled as graph data in which users and items are represented by nodes and purchase relationships between users and items and concurrent selling relationships between items are represented by edges. In particular, a recommender system technology is attracting attention to recommend items to users using a graph analysis technology such as a Graph Neural Network (GNN) for a bipartite graph focusing on the purchase relationships between users and items.

The recommender system technology uses the GNN to take in high-dimensional relationships based on edges between users and items and extract the feature of each of the users and items. On the other hand, in the recommender system technology, items are recommended to users based on the past purchase histories, which may cause a cold start problem in which items not purchased frequently by other users are difficult to recommend and a popularity bias problem in which only items frequently purchased by other users are easy to recommend.

As one method for reducing the above problems, there is a method (hereinafter refer to a conventional method) for adding a Global Attention term to each graph convolutional layer of the GNN in which a process using a graph convolutional layer, which is characterized by aggregating information about nodes based on the edges, is performed a plurality of times. The Global Attention term includes a key matrix, a query matrix and a value matrix, and is calculated by, for example, the product of the value matrix and the Attention Weight that is the product of the key matrix and query matrix normalized by the Softmax function. One convolutional layer of the GNN in which the Global Attention term is considered, can be modeled as given by the following equation (1).

$${E}^{l + 1} = ( 1 - β ) GCN ( {E}^{l} , M ) + β \times σ ( {E}^{l} {E}^{{l}^{T}} ) {E}^{l} \qquad ( 1 )$$

In the equation (1), a first term is a general Graph Convolution Network (GCN) term in which information about nodes is aggregated based on the edges, and a second term is a Global Attention term. Specifically, in the equation (1), E is a matrix in which information about nodes (vectors) are arranged, E^{l} indicates a query matrix and a value matrix, and Elt indicates a key matrix. Here, the superscript “l” indicates a 1-th layer of the graph convolutional layer, and the superscript “T” indicates a transposition. Thus, El is an information matrix of a 1-th node. In addition, β indicates a coefficient of the Global Attention term, M indicates an adjacency matrix which expresses the connection relation of edges between nodes, and σ indicates the Softmax function.

According to the equation (1), in the conventional method, the information items of the GCN term and Global Attention term in the 1-th layer are mixed and utilized as node information of the next l+1-th layer. In the conventional method, the Global Attention term in GNN can be interpreted as calculating an Attention Weight between a certain target node and a node in the graph and aggregating information about nodes to a target node according to the calculated Attention Weight. Therefore, in the conventional method, by making the coefficient of the Global Attention term negative, similarity between nodes can be reduced and classification performance of nodes can be improved.

In addition, the Global Attention term of the conventional method may regard the Attention Weight as a false edge. If the conventional method may be applied to the recommender system technology, the false edge can be a pseudo purchase relationship. It is thus expected that the advantageous effect of reducing the cold start problem and the popularity bias problem will be brought about by pseudo reduction and addition of purchases for items with a large purchase history and items with a small purchase history.

On the other hand, in the conventional method, it is considered that the addition of the Global Attention term increases the learnable weight matrix of the GNN and causes further learning of the similarity between nodes, thereby overlearning the training data. Therefore, there is a concern that the conventional method may decrease the performance.

### BRIEF DESCRIPTION OF THE DRAWINGS

FIG. 1 is a block diagram illustrating a configuration of a graph information processing apparatus according to a first embodiment.

FIG. 2 is a diagram showing a specific example of graph data in the first embodiment.

FIG. 3 is a flowchart illustrating an operation of the graph information processing apparatus according to the first embodiment.

FIG. 4 is a block diagram illustrating a configuration of a graph feature extraction unit in a modification to the first embodiment.

FIG. 5 is a diagram showing a specific example of graph data in a second embodiment.

FIG. 6 is a block diagram illustrating a configuration of a graph information processing apparatus according to a third embodiment.

FIG. 7 is a flowchart illustrating an operation of the graph information processing apparatus according to the third embodiment.

FIG. 8 is a diagram showing a specific example of graph data in the third embodiment.

FIG. 9 is a block diagram illustrating a configuration of a graph information processing apparatus according to a fourth embodiment.

FIG. 10 is a flowchart illustrating an operation of the graph information processing apparatus according to the fourth embodiment.

FIG. 11 is a table showing evaluation scores on a plurality of data sets using a plurality of inference methods including an inference method of the embodiments.

FIG. 12 is a block diagram illustrating a hardware configuration of a computer according to an embodiment.

### DETAILED DESCRIPTION

In general, according to one embodiment, a graph information processing apparatus acquires graph data and processing mode information including one of a learning mode and an inference mode, calculates a local message based on a connection relation between a plurality of nodes of the graph data, the local message being obtained by aggregating information about multiple nodes, calculates a global message based on similarity between the nodes, the global message being obtained by adding the information about nodes, mixes the local message and the global message based on weighted average weight to updates the information about nodes, outputs no flag if the processing mode information is the learning mode and output a flag if the processing mode information is the inference mode, updates the weight according to whether the flag is input, and outputs the updated information about nodes.

Embodiments of a graph information processing apparatus will be described below in detail with reference to the drawings. The graph data handled by the graph processing apparatus is data that represents a graph structure. The graph structure is a combination of nodes and edges that represent the relationships between a plurality of users and objects. The nodes are vertexes in the graph structure. The edges are sides connecting the nodes.

Specific examples of the graph data include (1) purchase data in which users and items are used as nodes, and purchase relationships between users and items and concurrent selling relationships between items are used as edges, (2) social network data in which users are used as nodes and friendships between users are used as edges, (3) molecular structure data in which atoms are used as nodes and connections between atoms are used as edges, (4) supply chain data in which companies are used as nodes and business relationships between companies are used as edges, (5) electrical circuit data in which circuit elements are used as nodes and connections between circuit elements are used as edges and (6) citation relationship data in which papers and Web pages are used as nodes and citation relationships between papers and Web pages are used as edges. In the following embodiments, an example of using (1) purchase data will be described.

Assume that the graph information processing apparatus uses a learning model of machine learning (machine learning model) for learning the above graph data. As the machine learning, for example, GNN, which is a kind of deep neural network (DNN), is used. That is, the machine learning model of the embodiments is a GNN model.

### First Embodiment

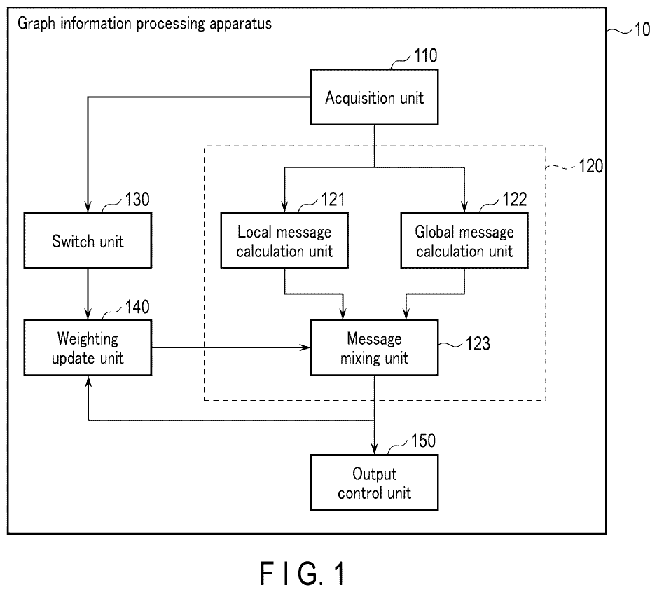

FIG. 1 is a block diagram illustrating a configuration of a graph information processing apparatus 10 according to a first embodiment. As illustrated in FIG. 1, the graph information processing apparatus 10 includes an acquisition unit 110, a graph feature extraction unit (extraction unit) 120, a switch unit 130, a weighting update unit (update unit) 140 and an output control unit 150. The graph feature extraction unit 120 includes a local message calculation unit (first calculation unit) 121, a global message calculation unit (second calculation unit) 122 and a message mixing unit (mixing unit) 123.

The acquisition unit 110 acquires processing mode information and graph data. The processing mode information is information for determining a processing mode of the graph information processing apparatus 10. The processing mode information includes a learning mode or an inference mode. The learning mode indicates a state in which the value of a learnable weight matrix in each section of the graph feature extraction unit 120 is updated. The inference mode indicates the value of a learnable weight matrix in each section of the graph feature extraction unit 120 is not updated. The graph data includes, for example, two or more nodes and one or more edges. The acquisition unit 110 outputs processing mode information to the switch unit 130 and outputs the graph data to the local message calculation unit 121 and the global message calculation unit 122.

Each of the nodes may have attribute information such as labels, categories and parameters as initial values. Each of the nodes may also have information of a degree in graph theory, that is, the number of edges connected to the nodes. For example, the attribute information of each of the nodes may be quantified by an embedded vector obtained by calculating node information by a co-occurrence relation of nodes included in a path obtained by randomly walking nodes based on edges such as Deepwalk and node2vec.

The above various items of information of the nodes may collectively be referred to as “node information (or information about nodes).” The node information of each of the nodes included in the graph data may collectively be called “a plurality of node information items (or information about multiple nodes).” The information about nodes may be a learnable weight.

The graph data acquired by the acquisition unit 110 may have a plurality of items of initialized node information. As the initialization, a general method such as uniform random numbers and Xavier may be used.

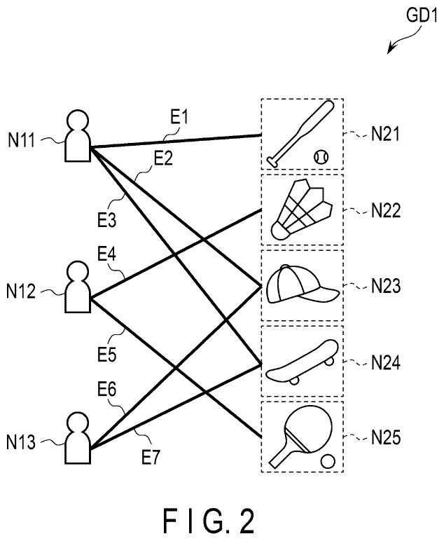

FIG. 2 is a diagram showing a specific example of the graph data in the first embodiment. For example, as shown in FIG. 2, in graph data GD1 in the first embodiment, the relationships between users N11, N12 and N13 and items N21, N22, N23, N24 and N25 are expressed by edges E1, E2, E3, E4, E5, E6 and E7.

The edges E1, E2 and E3 connect the user N11 and each of the items N21, N23 and N24. The edges E4 and E5 connect the user N12 and each of the items N22 and N25. The edges E6 and E7 connect the user N13 and each of the items N23 and N24.

The local message calculation unit 121 receives graph data from the acquisition unit 110. The local message calculation unit 121 calculates a local message into which information about multiple nodes is aggregated, on the basis of a connection relation between a plurality of nodes of the graph data. The local message calculation unit 121 outputs the calculated local message to the message mixing unit 123. Note that the information about nodes may be processed by normalization, the tanh function or the Softmax function when the local message is calculated. A plurality of combinations of these processes may be made. Before and after the processes, feature transformation may be performed using a learnable weight matrix.

Specifically, the local message calculating unit 121 aggregates a plurality of items of node information using, for example, one of the following equations (2) to (4) to calculate a local message.

$${m}_{u} = {\sum }_{i ∈ {N}_{u}} \frac{1}{\sqrt{\vert {N}_{u} \vert \vert {N}_{i} \vert}} {e}_{i} \qquad ( 2 )$$

$${m}_{u} = max \{ {e}_{i} : i ∈ {N}_{u} \} \qquad ( 3 )$$

$${m}_{u} = {\sum }_{i ∈ {N}_{u}} {e}_{i} \qquad ( 4 )$$

The equation (2) is LightGCN. In the equation (2), mu indicates a local message of target node u, eᵢ indicates information of source node i (node information), Nu and Ni indicate a set of nodes (node set) connected to their respective target node u and source node i, and |*| indicates the number of nodes included in the node set. According to the equation (2), a mean based on the number of adjacent nodes of the target node u and source node i is used as an aggregation technique.

As another aggregation technique, the maximum value (max) of the equation (3) or the sum (sum) of the equation (4) may be used. In place of the above LightGCN, a graph neural network (e.g., GCN, Neural Graph Collaborative Filtering (NGCF), and Message Passing Neural Networks (MPNNs)) having a message passing mechanism for performing an aggregate calculation of information about multiple nodes based on other edges may be used. The graph neural network or the like may include a learnable weight.

Note that the local message may be processed by normalization, the tanh function or the Softmax function. A plurality of combinations of these processes may be made. Before and after the processes, feature transformation may be performed using a learnable weight matrix.

The global message calculation unit 122 receives graph data from the acquisition unit 110. The global message calculation unit 122 calculates a global message into which information about multiple nodes are added, on the basis of similarity between a plurality of nodes of the graph data. The global message calculation unit 122 outputs the calculated global message to the message mixing unit 123. Note that the information about nodes may be processed by normalization, the tanh function or the Softmax function when the global message is calculated. A plurality of combinations of these processes may be made. Before and after the processes, feature transformation may be performed using a learnable weight matrix.

Specifically, the global message calculation unit 122 calculates a global message using, for example, the Global Attention technique shown in the following equation (5).

$$A = σ ( {EE}^{T} ) E \qquad ( 5 )$$

In the equation (5), A represents a matrix in which global messages of nodes are arranged, E represents a matrix in which information items of nodes are arranged (query matrix and value matrix), and ET represents a key matrix, and σ indicates the Softmax function.

In the equation (5), the order of operations may be changed. For example, the global message calculation unit 122 may calculate a global message using the following equation (6).

$$A = E σ ( {E}^{T} E ) \qquad ( 6 )$$

The equation (5) indicates that the inner product of the query and key matrices is calculated and then the Softmax function is processed in the node dimension direction. On the other hand, the equation (6) indicates that the inner product of the key and value matrices is calculated and then the Softmax function is processed in the feature dimension direction. Thus, the processing of the equation (6) can reduce the amount of calculation more than the processing of the equation (5).

Note that the Attention mechanism for calculating a global message may employ a technique other than the Global Attention described above. For example, the Attention mechanism may be Additive Attention, Dot-product Attention or Linear Attention. The Additive Attention is a technique of concatenating the query and key matrices and calculating Attention Weight by the FEN and Softmax function. The Dot-product Attention is a technique of calculating the product of the query and key matrices and calculating the Attention Weight by the Softmax function. The Linear Attention is a technique of calculating the product of the key and value matrices and then calculating the product of the calculated product and the query matrix. The Dot-product Attention and Linear Attention correspond to, for example, the equations (5) and (6), respectively. Note that for σ in, for example, the equations (5) and (6), normalization or the tanh function may be used instead of the Softmax function.

The message mixing unit 123 receives weight information from the weighting update unit 140, receives a local message from the local message calculation unit 121 and receives a global message from the global message calculation unit 122. The weight information is information of the weighted average weight. The message mixing unit 123 mixes the local message and the global message based on the weighted average weight and updates information about multiple nodes. The message mixing unit 123 outputs the weight information, local message and global message to the weighting update unit 140, and outputs the updated information about nodes to the weighting update unit 140 and the output control unit 150. Note that the weighted average weight used in the message mixing unit 123 may be referred to as “the weight of the message mixing unit 123.” Specifically, the message mixing unit 123 calculates node information using, for example, the following equation (6):

$${e}_{u} = ( 1 - a ) {m}_{u} + {aa}_{u} \qquad ( 7 )$$

In the equation (7), eᵤ represents information of a target node u (node information), au represents a global message of the target node u, and x represents a weighting coefficient of the weighted average. The message mixing unit 123 may set the initial value of the weighted average weight to a negative value. The weighted average weight may be regarded as a learnable weight.

Note that at least one of the local message, the global message and the information about nodes may be feature-transformed by the learnable weight matrix either before or after the processing of the message mixing unit 123. In addition, at least one of the local message, the global message and the information about nodes may be processed by activation functions such as the ReLU and the tanh functions.

The switch unit 130 receives processing mode information from the acquisition unit 110. The switch unit 130 determines whether or not an update flag is output based on the processing mode information. The switch unit 130 does not output the update flag to the weighting update unit 140 if the processing mode information is a learning mode, and outputs the update flag to the weighting update unit 140 if the processing mode information is an inference mode.

The weighting update unit 140 receives the weight information, local message, global message and updated information about nodes from the message mixing unit 123, and receives the update flag from the switch unit 130. The weighting update unit 140 does not update the weight of the message mixing unit 123 if it does not receive the update flag. On the other hand, the weighting update unit 140 updates the weight of the message mixing unit 123 under a predetermined condition if it receives the update flag. The predetermined condition is, for example, that the absolute value of the weight is decreased (updated to a value closer to zero than before). The weight is updated, for example, by actually evaluating the performance using the received information (e.g., weight information, local messages, global messages and updated information about nodes) and obtaining a weighted average weight that maximizes the performance. The weighting update unit 140 outputs the weight information to the message mixing unit 123 to update the weight of the message mixing unit 123.

Specifically, when updating the weight of the message mixing unit 123 (that is, when it is operated in the inference mode), the weighting update unit 140 outputs weight information including weight coefficient αₜₑₛₜ to the message mixing unit 123. Thus, the message mixing unit 123 changes a weight coefficient αₜᵣₐᵢₙ, which is the initial value set in the learning mode operation, to a weight coefficient αₜₑₛₜ in the inference mode.

Here, the relationship between the weight coefficient αₜᵣₐᵢₙ and the weight coefficient αₜₑₛₜ may be set so as to satisfy the following equation (8).

$${a}_{t r a i n} < {a}_{t e s t} \leq 0 \qquad ( 8 )$$

According to the above equation (8), the weight coefficient αₜₑₛₜ in the inference mode is larger than the weight coefficient αₜᵣₐᵢₙ (that is, the initial value) in the learning mode and has a value smaller than or equal to zero.

The output control unit 150 receives information about multiple nodes updated from the message mixing unit 123. The output control unit 150 outputs the updated information about nodes to an external device. The external device may be a display device such as a display or a server on a network.

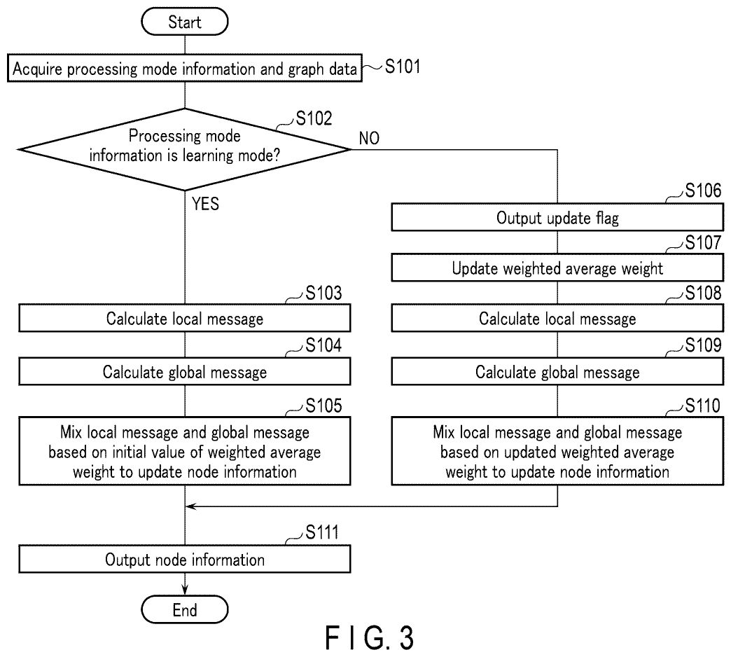

The configuration of the graph information processing apparatus 10 according to the first embodiment has been described above. The operation of the graph information processing apparatus 10 according to the first embodiment will be described below with reference to the flowchart of FIG. 3.

FIG. 3 is a flowchart illustrating the operation of the graph information processing apparatus according to the first embodiment. The process of the flowchart of FIG. 3 is started by, for example, selecting a data processing program by the user and executing a data processing program by a processor.

### (Step S101)

The acquisition unit 110 acquires processing mode information and graph data.

### (Step S102)

The graph information processing apparatus 10 determines whether the processing mode information is a learning mode or not. If the graph information processing apparatus 10 determines that the processing mode information is a learning mode, the process proceeds to step S103. If it determines that the processing mode information is not a learning mode (that is, if it determines that the processing mode information is an inference mode), the process proceeds to step S106.

### (Step S103)

The local message calculation unit 121 calculates a local message based on the graph data.

### (Step S104)

The global message calculation unit 122 calculates a global message on the basis of the graph data.

### (Step S105)

The message mixing unit 123 mixes the local message and the global message based on the initial value of the weighted average weight to update node information. After step S105, the process proceeds to step S111.

### (Step S106)

The switch unit 130 outputs an update flag.

### (Step S107)

The weighting update unit 140 updates the weighted average weight.

### (Step S108)

The local message calculation unit 121 calculates a local message based on the graph data.

### (Step S109)

The global message calculation unit 122 calculates a global message based on the graph data.

### Step S110)

The message mixing unit 123 mixes the local message and the global message based on the updated weighted average weight to update node information.

### (Step S111)

The output control unit 150 outputs the node information. After step S111, the flowchart of FIG. 3 ends.

As described above, the graph information processing apparatus according to the first embodiment acquires graph data and processing mode information including a learning mode or an inference mode, calculates a local message into which information about multiple nodes, which is information of a plurality of nodes of the graph data, are aggregated based on a connection relation between the nodes of the graph data, calculates a global message into which the information about nodes is added based on similarity between the nodes, mixes the local message and the global message based on a weighted average weight, updates the information about nodes, outputs no flag if the processing mode information is a learning mode, outputs a flag if the processing mode information is an inference mode, updates the weight according to whether a flag is input or not, and outputs the updated information about nodes.

Therefore, the graph information processing apparatus according to the first embodiment can be improved in its performance since the weighted average weight can be switched between the learning mode and the inference mode when the local message and the global message are mixed.

### (Modification to First Embodiment)

In the first embodiment, as has been described above, in the graph feature extraction unit, a series of processes of calculating a local message by the local message calculation unit, calculating a global message by the global message calculation unit, and updating information about multiple nodes by the message mixing unit is performed once. On the other hand, in a modification to the first embodiment, the series of processes is performed a plurality of times, as will be described below.

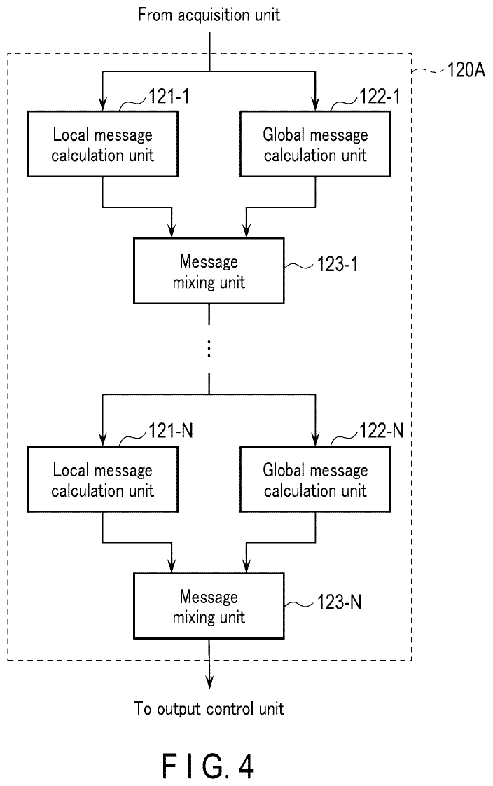

FIG. 4 is a block diagram illustrating a configuration of a graph feature extraction unit 120A in the modification to the first embodiment. As illustrated in FIG. 4, the graph feature extraction unit 120A includes a local message calculation unit 121-1, a global message calculation unit 122-1, a message mixing unit 123-1, . . . , a local message calculation unit 121-N, a global message calculation unit 122-N and a message mixing unit 123-N, where N is an integer of two or more.

For example, the message mixing unit 123-i (N>1≥1) receives an i-th local message from a local message calculation unit 121-i and receives an i-th global message from a global message calculation unit 122-i. The message mixing unit 123-i mixes the i-th local message and the i-th global message to update information about multiple nodes to a plurality of i-th information about nodes. Then, the message mixing unit 123-i outputs the i-th information about nodes to a local message calculation unit 121-(i+1) and a global message calculation unit 122-(i+1). In other words, the graph feature extraction unit 120A repeats a series of processes of calculating a local message, calculating a global message and updating information about multiple nodes N times.

The output control unit in the modification to the first embodiment may output information about multiple nodes which are updated by performing a predetermined process on at least one of information about multiple nodes of the graph data at the time of acquisition and information about multiple nodes of each process performed a plurality of times. The predetermined process may be concatenation, a maximum value, a sum or an average value.

As described above, the graph information processing apparatus according to the modification to the first embodiment acquires graph data and processing mode information including a learning mode or an inference mode, calculates a local message into which information about multiple nodes, which is information of a plurality of nodes of the graph data, are aggregated based on a connection relation between the nodes of the graph data, calculates a global message into which the information about nodes is added based on the similarity between the nodes, mixes the local message and the global message based on a weighted average weight, updates the information about nodes, outputs no flag if the processing mode information is a learning mode, outputs a flag if the processing mode information is an inference mode, updates the weight according to whether a flag is input or not, and outputs the updated information about nodes.

In addition, the graph information processing apparatus according to the modification to the first embodiment performs a series of processes of calculating a local message, calculating a global message, and updating information about multiple nodes a plurality of times, performs a predetermined process on at least one of information about multiple nodes of the graph data at the time of acquisition and information about multiple nodes of each process performed a plurality of times.

Therefore, the graph information processing apparatus according to the modification to the first embodiment can improve in its performance by performing a series of processes of calculating a local message, calculating a global message, and updating information about multiple nodes a plurality of times.

### Second Embodiment

In the first embodiment, even though the categories of the nodes is known as in the bipartite graph of users and items illustrated in FIG. 2, a global message is calculated without distinguishing the categories. Thus, the first embodiment has a problem that information items of the nodes are aggregated even though there is a good relationship between the nodes whose information items need not be aggregated. Therefore, in the second embodiment, using graph data classified into a plurality of groups, Global Attention is calculated between the groups (inter) or within the groups (intra).

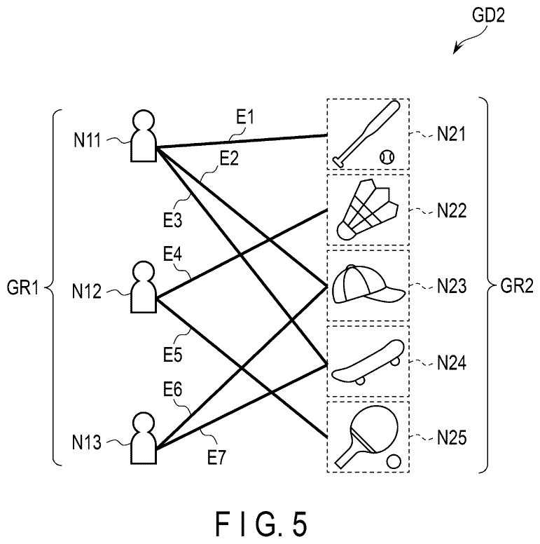

FIG. 5 is a diagram showing a specific example of graph data in the second embodiment. For example, as shown in FIG. 5, graph data GD2 in the second embodiment represents the relationships between users N11, N12 and N13 and items N21, N22, N23, N24 and N25 by edges E1, E2, E3, E4, E5, E6 and E7. The graph data GD2 also classifies the users N11, N12 and N13 into a group GR1 and classifies the items N21, N22, N23, N24 and N25 into a group GR2. Note that the connection relation of the edges will not be described because it is similar to that in the graph data GD1 shown in FIG. 2.

The first and second embodiments differ in the processing of graph data classified into a plurality of groups in the global message calculation unit. Accordingly, the processing in the global message calculation unit will be described below.

The global message calculation unit in the second embodiment calculates a global message into which information about multiple nodes is are added based on the similarity between a plurality of nodes, which is normalized for each of the groups. Specifically, the global message calculation unit in the second embodiment calculates a global message into which information about multiple nodes based on similarity between a first node in the graph data and a second node belonging to one of the groups, which is normalized for each of the groups. The first and second nodes may belong to different groups or the same group.

More specifically, the global message calculation unit in the second embodiment calculates a global message using, for example, the Global Attention technique shown in the following equations (9) and (10). Note that the equation (9) is used to calculate a global message between the groups (inter), and the equation (10) is used to calculate a global message within the groups (intra).

$${A}_{U} = σ ( {E}_{I} {E}_{U}^{T} ) {E}_{I} \qquad ( 9 )$$

$${A}_{U} = σ ( {E}_{U} {E}_{U}^{T} ) {E}_{U} \qquad ( 10 )$$

In the equations (9) and (10), U indicates all users and I indicates all items. Accordingly, Au indicates a matrix in which global messages of all user nodes are arranged, Eᵤ indicates a matrix in which information items of all user nodes are arranged, and Er indicates a matrix in which information items of all item nodes are arranged. The processing of σ (e.g., Softmax function) can be calculated for each of the groups. In addition, the calculation of the global messages using the equations (9) and (10) need not necessarily be performed among or within all the groups. Note that for σ in, for example, the equations (9) and (10), normalization or the tanh function may be used instead of the Softmax function.

Note that the global message calculation unit in the second embodiment may calculate a plurality of global messages AU and then perform a processing on a maximum value, a sum or an average value. The global message calculation unit also calculates the matrix Ar in which the global messages of all item nodes are arranged in the same manner as described above. The equations (9) and (10) may be changed in order of calculation. This is similar to the transformation from the equation (5) to the equation (6).

As described above, the graph information processing apparatus according to the second embodiment acquires graph data and processing mode information including a learning mode or an inference mode, calculates a local message into which information about multiple nodes, which is information of a plurality of nodes of the graph data, are aggregated based on a connection relation between the nodes of the graph data, calculates a global message into which the information about nodes is added based on the similarity between the nodes, mixes the local message and the global message based on a weighted average weight, updates the information about nodes, outputs no flag if the processing mode information is a learning mode, outputs a flag if the processing mode information is an inference mode, updates the weight according to whether a flag is input or not, and outputs the updated information about nodes.

In addition, the graph information processing apparatus according to the second embodiment calculates a global message into which information about multiple nodes is added based on similarity between the nodes, which is normalized for each of a plurality of groups.

Therefore, the graph information processing apparatus according to the second embodiment can eliminate unnecessary aggregation of information items between nodes by calculating a global message in consideration of a plurality of groups in the graph data.

### Third Embodiment

In the second embodiment, Global Attention is calculated using graph data classified into a plurality of predetermined groups. However, it is conceivable that the optimal group may change during learning. Thus, the first embodiment has a problem in that it cannot cope with the change in the group during learning. Therefore, in the third embodiment, a group detection unit that classifies a plurality of nodes into a plurality of groups using a group detection flag is added.

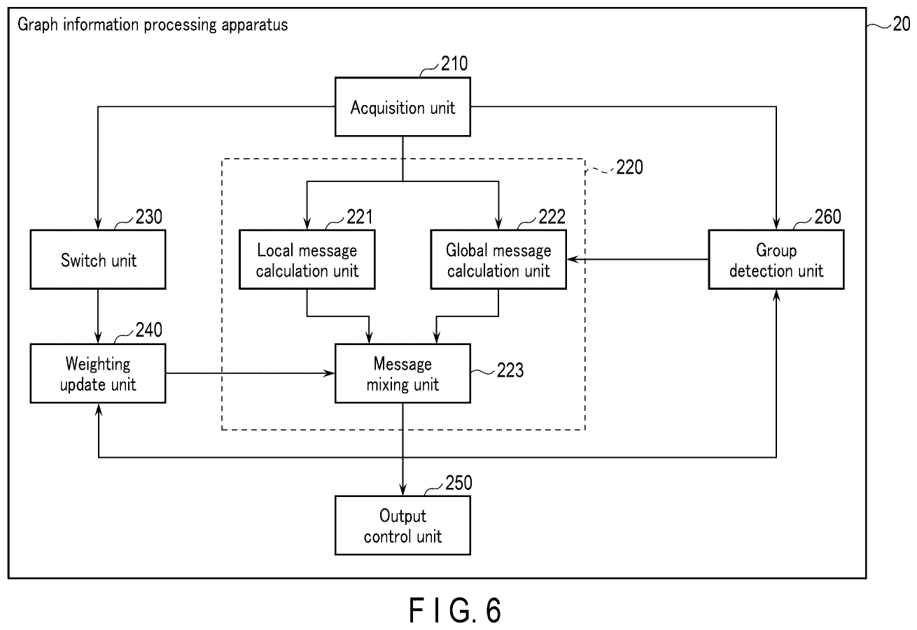

FIG. 6 is a block diagram illustrating a configuration of a graph information processing apparatus 20 according to the third embodiment. As illustrated in FIG. 6, the graph information processing apparatus 20 includes an acquisition unit 210, a graph feature extraction unit 220, a switch unit 230, a weighting update unit (update unit) 240, an output control unit 250 and a group detection unit (detection unit) 260. The graph feature extraction unit 220 includes a local message calculation unit (first calculation unit) 221, a global message calculation unit (second calculation unit) 222 and a message mixing unit (mixing unit) 223. Hereinafter, the matters related only to the third embodiment will be described, and the others will not be described because they are similar to the units of the graph information processing apparatus 10 according to the first embodiment.

The acquisition unit 210 acquires processing mode information and graph data and further acquires a group detection flag with optional timing. The acquisition unit 210 outputs the graph data and group detection flag to the group detection unit 260.

The group detection unit 260 receives the graph data and group detection flag from the acquisition unit 210 and receives information about multiple nodes updated from the message mixing unit 223. Based on the information about nodes and the connection relation between a plurality of nodes of the graph data, the group detection unit 260 classifies the nodes into a plurality of groups. The group detection unit 260 outputs to the global message calculation unit 222 information obtained by classifying the nodes into the groups (group information).

Specifically, the group detection unit 260 classifies a plurality of nodes into a plurality of groups by using a predetermined clustering method. The predetermined clustering method is, for example, k-means or spectral clustering. If the graph data is a bipartite graph and the nodes are categorized, the group detection unit 260 may replace the category of each of the nodes with a group for classification.

Note that the group detecting unit 260 may classify the nodes into a plurality of groups based on information about multiple nodes (e.g., a plurality of initial information about nodes that have not yet updated) of the graph data and the connection information between the nodes of the graph data.

Upon receiving group information from the group detection unit 260, the global message calculation unit 222 calculates a global message into which information about multiple nodes is added based on similarity between the nodes, which is normalized for each of the groups. Assuming here that with respect to optional groups G1 and group G2 among the classified groups, all nodes in the group G1 are Glupdate and all nodes in the group G2 are G2_{update}, the global message calculation unit 222 calculates a global message using, for example, the Global Attention method indicated in the following equation (11). The equation (11) is used to calculate a global message between the groups (inter).

$${A}_{G {1}_{update}} = σ ( {E}_{G {2}_{update}} {E}_{G {1}_{update}}^{T} ) {E}_{G {2}_{update}} \qquad ( 11 )$$

Note that the calculation of a global message within the groups (intra) by the global message calculation unit 222, that of a matrix in which the global messages of all the item nodes are arranged by the global message calculation unit 222, or the like will not be described because they may be similar to those in the second embodiment. The equation (11) may be changed in order of operation. This is similar to the transformation from the equation (5) to the equation (6).

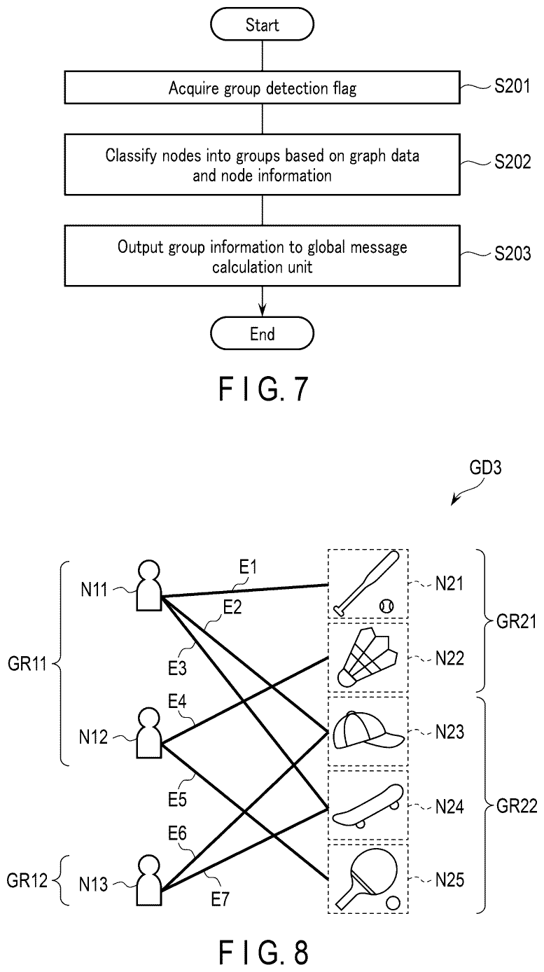

The configuration of the graph information processing apparatus 20 according to the third embodiment has been described above. The operation of the graph information processing apparatus 20 according to the third embodiment will be described below with reference to the flowchart of FIG. 7.

FIG. 7 is a flowchart illustrating the operation of the graph information processing apparatus 20. The process of the flowchart of FIG. 7 is started, for example, upon receipt of a group detection flag during the execution of the data processing program in the first embodiment.

### (Step S201)

The acquisition unit 210 acquires a group detection flag.

### (Step S202)

The group detection unit 260 classifies nodes into groups based on graph data and node information.

### (Step S203)

The group detection unit 260 outputs group information to the global message calculation unit 222. After step S203, the flowchart of FIG. 7 ends.

FIG. 8 is a diagram showing a specific example of graph data in the third embodiment. For example, as shown in FIG. 8, graph data GD3 in the third embodiment represents the relationships between users N11, N12 and N13 and items N21, N22, N23, N24 and N25 by edges E1, E2, E3, E4, E5, E6 and E7. The graph data GD3 also classifies the users N11 and N12 into a group GR21 and classifies the items N23, N24 and N25 into a group GR22. Note that the connection relation of the edges will not be described because it is similar to that in the graph data GD1 shown in FIG. 2. The graph data GD3 can also be regarded as an example in which unclassified graph data items are classified into groups by the group detecting unit 260. In addition, the graph data GD3 may include information of the group GR1 including groups GR11 and GR12 and information of the group GR2 including groups GR21 and GR22, which are groupings of the graph data GD2 of FIG. 5.

As described above, the graph information processing apparatus according to the third embodiment acquires graph data and processing mode information including a learning mode or an inference mode, calculates a local message into which information about multiple nodes, which is information of a plurality of nodes of the graph data, are aggregated based on a connection relation between the nodes of the graph data, calculates a global message into which the information about nodes is are added based on the similarity between the nodes, mixes the local message and the global message based on a weighted average weight, updates the information about nodes, outputs no flag if the processing mode information is a learning mode, outputs a flag if the processing mode information is an inference mode, updates the weight according to whether a flag is input or not, and outputs the updated information about nodes.

In addition, the graph information processing apparatus according to the third embodiment further acquires a group detection flag to classify a plurality of nodes into a plurality of groups based on graph data or information about multiple nodes and a connection relation.

Therefore, the graph information processing apparatus according to the third embodiment can be adapted to a change in group during learning by classifying a plurality of nodes of graph data into a plurality of groups with optional timing, and thus can bring about an advantageous effect of updating the grouping of the nodes.

### Fourth Embodiment

In the first to third embodiments, node information is calculated by focusing on the relationship between nodes in the graph data. On the other hand, in the fourth embodiment, a recommendation task (link prediction) is performed as a process in the inference mode.

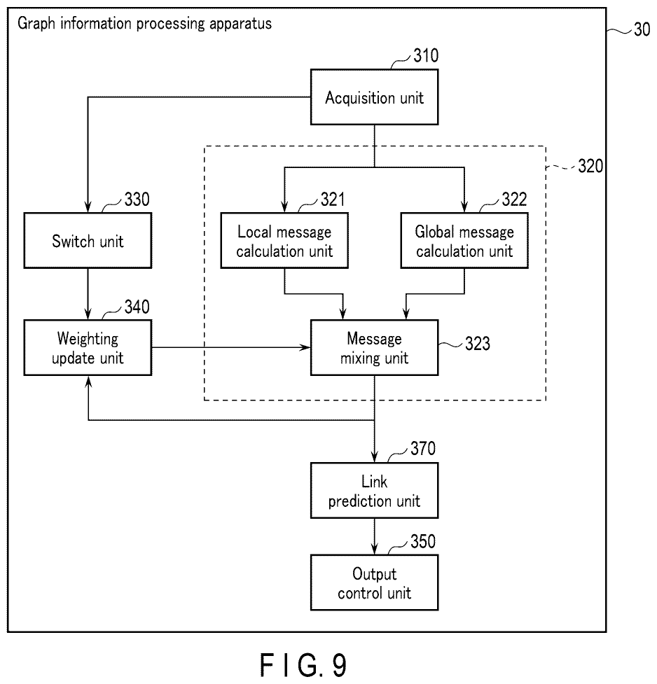

FIG. 9 is a block diagram illustrating a configuration of a graph information processing apparatus 30 according to the fourth embodiment. As illustrated in FIG. 9, the graph information processing apparatus 30 includes an acquisition unit 310, a graph feature extraction unit (extraction unit) 320, a switch unit 330, a weighting update unit (update unit) 340, an output control unit 350 and a link prediction unit (prediction unit) 370. The graph feature extraction unit 320 includes a local message calculation unit (first calculation unit) 321, a global message calculation unit (second calculation unit) 322 and a message mixing unit (mixing unit) 323. Hereinafter, the matters related only to the fourth embodiment will be described, and the others will not be described because they are similar to those of the graph information processing apparatus 10 according to the first embodiment.

The link prediction unit 370 receives information about multiple nodes updated from the message mixing unit 323. The link prediction unit 370 calculates similarity between a plurality of nodes based on the updated information about nodes. The calculated similarity is, for example, an inner product and cosine similarity. The link prediction unit 370 outputs the similarity between the nodes to the output control unit 350 as similarity information.

The output control unit 350 receives the similarity information from the link prediction unit 370. The output control unit 350 outputs the similarity information to an external device. The external device may be a display device such as a display and a server on a network.

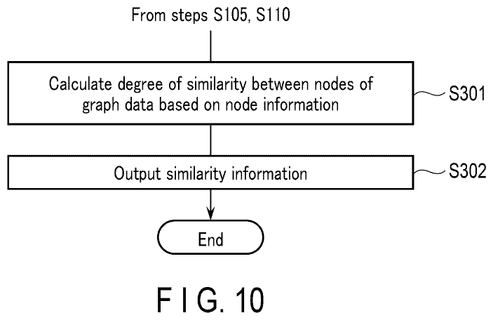

The configuration of the graph information processing apparatus 30 according to the fourth embodiment has been described above. The operation of the graph information processing apparatus 30 will be described below with reference to the flowchart of FIG. 10.

FIG. 10 is a flowchart illustrating the operation of the graph information processing apparatus according to the fourth embodiment. The flowchart of FIG. 10 is an addition to the flowchart of FIG. 3. Specifically, after steps S105 and S110 in the flowchart of FIG. 3, the process proceeds to step S301 in the flowchart of FIG. 10.

### (Step S301)

The link prediction unit 370 calculates similarity between nodes of graph data based on node information.

### (Step S302)

The output control unit 350 outputs similarity information. After step S302, the flowchart of FIG. 10 ends.

As described above, the graph information processing apparatus according to the fourth embodiment acquires graph data and processing mode information including a learning mode or an inference mode, calculates a local message into which information about multiple nodes, which is information of a plurality of nodes of the graph data, are aggregated based on a connection relation between the nodes of the graph data, calculates a global message into which the information about nodes is added based on the similarity between the nodes, mixes the local message and the global message based on a weighted average weight, updates the information about nodes, outputs no flag if the processing mode information is a learning mode, outputs a flag if the processing mode information is an inference mode, updates the weight according to whether a flag is input or not, and outputs the updated information about nodes.

The graph information processing apparatus according to the fourth embodiment also calculates similarity between the nodes based on the updated information about nodes, and outputs the calculated similarity between the plurality of nodes.

Therefore, the graph information processing apparatus according to the fourth embodiment can perform link prediction as a process in the inference mode.

### Fifth Embodiment

In the first embodiment, the weighting update unit updates the weighted average weight of the message mixing unit. If the weighted average weight is, for example, zero, the node information can be updated without calculating a global message by the global message calculating unit.

However, the first embodiment has a problem that the calculation in the global message calculation unit cannot be avoided. Therefore, in the fifth embodiment, the switch unit outputs a stop flag to stop the calculation in the global message calculation unit. The configuration of the graph information processing apparatus according to the fifth embodiment will be described below using the respective units of the graph information processing apparatus 10 shown in FIG. 1 because it is substantially the same as that of the graph information processing apparatus according to the first embodiment.

The acquisition unit 110 acquires processing mode information and graph data, and further acquires stop information with optional timing. The acquisition unit 110 outputs the stop information to the switch unit 130.

The switch unit 130 receives the stop information from the acquisition unit 110. The switch unit 130 determines the output of a stop flag based on the stop information. When the switch unit 130 receives the stop information, if the processing mode is the inference mode, the switch unit 130 outputs the stop flag to the global message calculation unit 122 and the weighting update unit 140.

The global message calculation unit 122 receives the stop flag from the switch unit 130. Upon receiving the stop flag, the global message calculation unit 122 stops the calculation of a global message. Thus, the global message calculation unit 122 does not output the global message to the message mixing unit 123.

The weighting update unit 140 receives the stop flag from the switch unit 130. Upon receiving the stop flag, the weighting update unit 140 updates the weight of the message mixing unit 123 to zero. The weighting update unit 140 outputs weight information of zero weight to the message mixing unit 123 to update the weight of the message mixing unit 123 to zero.

Specifically, when updating the weight of the message mixing unit 123 to zero (that is, when operating in the inference mode and not calculating a global message), the weighting update unit 140 outputs weight information having a weight coefficient of zero to the message mixing unit 123. Thus, in the message mixing unit 123, the weighting coefficient train, which is an initial value set in the operation of the learning mode, is changed to zero. If the weight of the message mixing unit 123 becomes zero, the node information output from the message mixing unit 123 is given by the following equation (12).

$${e}_{u} = {m}_{u} \qquad ( 12 )$$

As described above, the graph information processing apparatus according to the fifth embodiment acquires graph data and processing mode information including a learning mode or an inference mode, calculates a local message into which information about multiple nodes, which is information of a plurality of nodes of the graph data, are aggregated based on a connection relation between the nodes of the graph data, calculates a global message into which the information about nodes are added based on the similarity between the nodes, mixes the local message and the global message based on a weighted average weight, updates the information about nodes, outputs no flag if the processing mode information is a learning mode, outputs a flag if the processing mode information is an inference mode, updates the weight according to whether a flag is input or not, and outputs the updated information about nodes.

The graph information processing apparatus according to the fifth embodiment further acquires stop information. In the case of the inference mode, the graph information processing apparatus outputs a stop flag to stop the calculation of a global message and updates the weight to zero. When the calculation of a global message is stopped, the graph information processing apparatus updates information about multiple nodes using only the local message.

Therefore, the graph information processing apparatus according to the fifth embodiment can be improved in its calculation efficiency by omitting the calculation of a global message in the processing in the inference mode.

### (Evaluation Results)

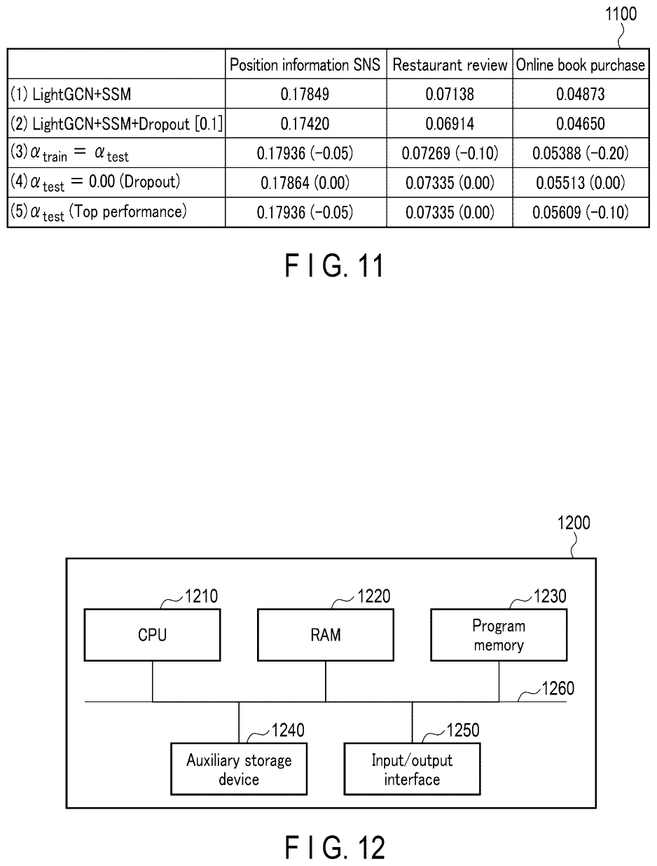

FIG. 11 is a table showing evaluation scores on a plurality of data sets using a plurality of inference methods including the inference method of the embodiments. As shown in FIG. 11, a table 1100 shows the relationship between five inference methods and three data sets. The five inference methods are (1) LightGCN+SSM (sampled softmax), (2) LightGCN+SSM+Dropout [0.1], (3) αₜᵣₐᵢₙ=αₜₑₛₜ, (4) αₜₑₛₜ=0.00 (Dropout), and (5) αₜₑₛₜ (top performance). Of these interference methods, the inference methods (3) to (5) are based on the above embodiments.

The three data sets are location information social networking service (SNS) (e.g., Gowalla Dataset), restaurant review (e.g., Yelp Dataset), and online book purchase (e.g., Amazon-Book Dataset).

The evaluation scores are obtained by calculating the inner product between users and items and calculating the Recall of the top 20 ranked items predicted for each of the users. According to the table 1100, the evaluation scores of each of the inference methods (3) to (5) based on the embodiments are higher than those of the existing inference methods (1) and (2). In particular, the evaluation scores of the online book purchase are significantly higher.

It can be seen from the above that the inference methods of the embodiments can be expected to improve the performance compared with the existing inference methods.

### (Hardware Configuration)

FIG. 12 is a block diagram illustrating a hardware configuration of a computer 1200 according to an embodiment. The computer 1200 includes, as hardware, a central processing unit (CPU) 1210, a random access memory (RAM) 1220, a program memory 1230, an auxiliary storage device 1240 and an input/output interface 1250. The CPU 1210 communicates with the RAM 1220, program memory 1230, auxiliary storage device 1240 and input/output interface 1250 via a bus 1260.

The CPU 1210 is an example of a general-purpose processor. The RAM 1220 is used by the CPU 1210 as a working memory. The RAM 1220 includes a volatile memory such as a synchronous dynamic random access memory (SDRAM). The program memory 1230 stores a variety of programs including data processing programs. As the program memory 1230, for example, a read-only memory (ROM), part of the auxiliary storage device 1240, or a combination thereof is used. The auxiliary storage device 1240 stores data non-transitorily. The auxiliary storage device 1240 includes a nonvolatile memory such as an HDD and an SSD.

The input/output interface 1250 is an interface for connecting or communicating with other devices. The input/output interface 1250 is used, for example, for connecting or communicating each of the acquisition units 110, 210 and 310 shown in FIGS. 1, 6 and 9 with external devices (e.g., an input/output device and a server device) and for connecting or communicating each of the output control units 150, 250 and 350 to the external devices.

Each of the programs stored in the program memory 1230 includes computer executable instructions. When the programs (computer executable instructions) are executed by the CPU 1210, they causes the CPU 1210 to perform a predetermined process. For example, when the data processing program are executed by the CPU 1210, they causes the CPU 1210 to perform a series of processes described with respect to the units shown in FIGS. 1, 6 and 9.

The programs may be provided for the computer 1200 while being stored in a computer readable storage medium. In this case, for example, the computer 1200 further includes a drive (not shown) which reads data from the storage medium to acquire a program from the storage medium. Examples of the storage medium include a magnetic disk, an optical disk (CD-ROM, CD-R, DVD-ROM, DVD-R, etc.), a magneto-optical disk (e.g., MO) and a semiconductor memory. In addition, the programs may be stored in a server on the communication network, and the computer 1200 may use the input/output interface 1250 to download the programs from the server.

The processes described in the embodiment need not be performed by a general-purpose hardware processor such as the CPU 1210, but may be performed by a dedicated hardware processor such as an application specific integrated circuit (ASIC). The term “processing circuitry (processing unit) includes at least one general-purpose hardware processor, at least one dedicated hardware processor, or a combination of at least one general-purpose hardware processor and at least one dedicated hardware processor. In the example shown in FIG. 12, the CPU 1210, RAM 1220 and program memory 1230 correspond to the processing circuitry.

Note that each of the flowcharts described above is only one example. The steps of the flowcharts may be changed in order or the like to the extent possible, or other steps may be added thereto.

Each of the above embodiments can improve the performance.

While certain embodiments have been described, these embodiments have been presented by way of example only, and are not intended to limit the scope of the inventions. Indeed, the novel embodiments described herein may be embodied in a variety of other forms; furthermore, various omissions, substitutions and changes in the form of the embodiments described herein may be made without departing from the spirit of the inventions. The accompanying claims and their equivalents are intended to cover such forms or modifications as would fall within the scope and spirit of the inventions.

What is claimed is:

1. A graph information processing apparatus comprising processing circuitry configured to:
acquire graph data and processing mode information including one of a learning mode and an inference mode;
calculate a local message based on a connection relation between a plurality of nodes of the graph data, the local message being obtained by aggregating information about multiple nodes;
calculate a global message based on similarity between the nodes, the global message being obtained by adding the information about nodes;
mix the local message and the global message based on weighted average weight to update the information about nodes;
output no flag if the processing mode information is the learning mode and output a flag if the processing mode information is the inference mode;
update the weight according to whether the flag is input; and
output the updated information about nodes.

2. The graph information processing apparatus according to claim 1,
the processing circuitry is further configured not to update the weight if no flag is input; and
the processing circuitry is further configured to mix the local message and the global message using the weight for the global message as a negative initial value.

3. The graph information processing apparatus according to claim 2, the processing circuitry is further configured to:
update the weight if the flag is input; and
mix the local message and the global message using the weight for the global message as a value between the initial value and zero.

4. The graph information processing apparatus according to claim 1, wherein
the nodes of the graph data are classified into a plurality of groups; and
the processing circuitry is further configured to calculate the global message, which is obtained by adding the information about nodes, based on similarity between the nodes, which is normalized for each of the groups.

5. The graph information processing apparatus according to claim 1, the processing circuitry is further configured to:
acquire a group detection flag; and
classify the nodes into a plurality of groups based on the connection relation and one of the graph data and the information about nodes when the group detection flag is acquired.

6. The graph information processing apparatus according to claim 5, the processing circuitry is further configured to
calculate the global message obtained by adding the information about nodes based on similarity between the nodes, which is normalized for each of the groups.

7. The graph information processing apparatus according to claim 1, the processing circuitry is further configured to:
calculate similarity between the nodes based on the updated information about nodes; and
output the calculated similarity between the nodes.

8. The graph information processing apparatus according to claim 1, the processing circuitry is further configured to:
acquire stop information;
output a stop flag when the stop information is acquired and in the inference mode;
stop calculation of the global message when the stop flag is output;
update the weight to zero when the stop flag is output; and
update the information about nodes using only the local message when the calculation of the global message is stopped.

9. The graph information processing apparatus according to claim 8,
the processing circuitry is further configured not to update the weight if no flag is output; and
the processing circuitry is further configured to mix the local message and the global message using the weight for the global message as a negative initial value.

10. The graph information processing apparatus according to claim 1, wherein the graph data includes information about multiple nodes which are initialized when the graph data is acquired.

11. The graph information processing apparatus according to claim 10, wherein the initialization has a method of one of uniform random numbers and Xavier.

12. The graph information processing apparatus according to claim 1, wherein the information about nodes is a learnable weight.

13. The graph information processing apparatus according to claim 1, wherein the processing circuitry is further configured to aggregate the information about nodes by a graph neural network having a message passing mechanism.

14. The graph information processing apparatus according to claim 13, wherein the graph neural network is one of Graph Convolution Networks (GCN), LightGCN, Neural Graph Collaborative Filtering (NGCF) and Message Passing Neural Networks (MPNNs).

15. The graph information processing apparatus according to claim 1, the processing circuitry is further configured to calculate the global message by an attention mechanism including a key matrix, a query matrix and a value matrix.

16. The graph information processing apparatus according to claim 15, wherein the attention mechanisms is one of Additive Attention, Dot-product Attention and Linear Attention.

17. The graph information processing apparatus according to claim 1, wherein
a series of processes of calculating the local message, calculating the global message, and updating the information about nodes is performed a plurality of times; and
the processing circuitry is further configured to perform a predetermined process on at least one of information about multiple nodes of the acquired graph data and information about multiple nodes of each of the processes performed a plurality of times, and output the updated information about nodes.

18. The graph information processing apparatus according to claim 5, the processing circuitry is further configured to classify the nodes into a plurality of groups using a predetermined clustering method.

19. A graph information processing method comprising:
acquiring graph data and processing mode information including one of a learning mode and an inference mode;
calculating a local message based on a connection relation between a plurality of nodes of the graph data, the local message being obtained by aggregating information about multiple nodes that is information of the nodes;
calculating a global message based on similarity between the nodes, the global message being obtained by adding the information about nodes;
mixing the local message and the global message based on weighted average weight to update the information about nodes;
outputting no flag if the processing mode information is the learning mode and output a flag if the processing mode information is the inference mode;
updating the weight according to whether the flag is input; and
outputting the updated information about nodes.

20. A non-transitory computer-readable storage medium storing a program for causing a computer to execute processing comprising:
acquiring graph data and processing mode information including one of a learning mode and an inference mode;
calculating a local message based on a connection relation between a plurality of nodes of the graph data, the local message being obtained by aggregating information about multiple nodes;
calculating a global message based on similarity between the nodes, the global message being obtained by adding the information about nodes;
mixing the local message and the global message based on weighted average weight to update the information about nodes;
outputting no flag if the processing mode information is the learning mode and output a flag if the processing mode information is the inference mode;
updating the weight according to whether the flag is input; and
outputting the updated information about nodes.
